(19) United States
(12) Patent Application Publication
(10) Pub. No.: US 2009/0030220 A1
(43) Pub. Date: Jan. 29, 2009

(54) Transparent desiccating agent

(76) Inventors: Teruo Uchibori, Shiga (JP); Kaneto Ohyama, Shiga (JP); Yusuke Nakajima, Shiga (JP); Shouichi Aoki, Fukui (JP); Shinichi Miura, Fukui (JP); Yui Segawa, Fukui (JP)

Correspondence Address: KRATZ, QUINTOS & HANSON, LLP, 1420 K Street, N.W., Suite 400, WASHINGTON, DC, 20005, US

(21) Appl. No.: 11/659,041

(22) PCT Filed: Jul. 28, 2005
(86) PCT No.: PCT/JP05/13874

§ 371 Date: Jan. 31, 2007

(30) Foreign Application Priority Data
Aug. 2, 2004 (JP) 2004-226096

(51) Int. Cl. C07F 11/00; C07F 5/06; C07F 5/02; C07F 7/02

(52) U.S. Cl. 556/51; 556/170; 556/400; 568/1; 568/300

(57) ABSTRACT

The present invention provides a transparent desiccant with a high moisture absorption capacity which is suitable for use as a desiccant for organic EL devices (especially top-emitting organic EL devices). More particularly, the invention provides a transparent desiccant comprising an organometallic compound obtained by reacting a metal alkoxide with a polyol.

### TECHNICAL FIELD

The present invention relates to transparent desiccants useful in organic EL devices.

### BACKGROUND ART

Displays using organic EL devices have recently attracted attention as displays replacing cathode ray tube displays, liquid crystal displays, etc.

An organic EL device comprises at least one organic layer and a pair of thin-film electrodes. For example, one known structure sequentially includes an anode, a hole-transporting layer, a light-emitting layer (organic light-emitting layer), an electron-transporting layer, and a cathode over a glass substrate (see FIG. 1).

Metals with high work functions, such as tin oxide, indium oxide, alloys and compounds thereof, etc., are used as anodes; in general, ITO transparent electrode layers are frequently used as anodes. Metal materials effective at electron injection and having low work functions are preferable as cathodes; for example, aluminum, magnesium, and alloys thereof, etc., are used.

The light-emission mechanism of organic EL devices is as follows. When voltage is applied between the anode and cathode of an organic EL device, holes injected from the anode and electrons injected from the cathode combine in the interior of the light-emitting layer, causing the emission in a color that corresponds to the kind of organic light-emitting material.

Advantages of displays using organic EL devices over existing displays such as cathode ray tubes, liquid crystal displays, etc., include the following:

(1) capable of being made thinner because they are self-emitting and do not require backlights;

(2) capable of low-power operation because they provide extremely high luminance at a voltage of about 10 V;

(3) exhibiting excellent suitability for displaying moving images because they respond in as fast as several microseconds; and

(4) having wide viewing angles.

However, displays using organic EL devices have a drawback in that the luminescent characteristics, such as luminance and uniformity of luminance, deteriorate after operation for a certain period. Such luminescent characteristics are very likely to deteriorate particularly in the presence of moisture: oxidization or stripping of electrodes, degradation of organic material, etc., may occur, resulting in the growth of non-emission portions termed “darkspots”, and hence a shortened device lifetime.

Attempts to improve this drawback have been made, such as, for example, developing novel organic light-emitting materials, enhancing airtightness by improving seal materials or developing protection films, etc. Attempts have also been made to prevent degradation of organic EL devices by placing a desiccant powder or hygroscopic sheet in an organic EL device to maintain a low humidity environment inside the device. For example, Patent Document 1 discloses maintaining a dry atmosphere by placing BaO powder in a device.

In order to further increase the lifetime of organic EL devices, the use of a top-emitting device structure instead of the conventional bottom-emitting device structure has also been explored. For example, as shown in FIG. 2, one type of organic EL device structure includes a transparent substrate such as glass, a transparent electrode layer on the substrate, and an opaque seal member. This structure is referred to as a “bottom-emitting” type, wherein light emitted from the organic EL device exits through the substrate. On the other hand, an organic EL device structure which includes an opaque electrode on the substrate and a transparent electrode layer near the seal member is referred to as the “top-emitting” type. With this structure, light emitted from the organic EL device exits through the seal member (see FIG. 3).

Because light emitted from a bottom-emitting organic EL device exits through the substrate, the organic EL device is equipped with a drive (e.g., power supply), which makes the aperture ratio limited. Moreover, the device requires high-voltage operation in order to provide a given level of luminance, owing to reductions in external luminous efficiency. Therefore, the organic light-emitting material undergoes significant deterioration, and hence the device lifetime is relatively short.

With a top-emitting organic EL device, light exits through the top electrode; therefore, the device has little reduction in aperture ratio by the installation of a drive, and thereby exhibits high external luminous efficiency. Therefore, the device is capable of low-voltage operation, resulting in less deterioration of the organic light-emitting material, and hence a longer device lifetime.

For the foregoing reasons, top-emitting organic EL devices are preferable in terms of extending organic EL device lifetime. However, the application of desiccants to top-emitting organic EL devices is difficult, because currently available desiccants in powder and sheet forms are not transparent, and desiccants are most frequently placed on a seal cap.

As an approach to overcoming this problem, for example, Patent Document 2 discloses using a transparent moisture capturing film for top-emitting organic EL devices. This moisture capturing film is, however, insufficient in moisture absorption capacity in view of long-term use, and therefore leaves much room for enhanced practicality.

Patent Document 3 teaches a transparent desiccant film prepared by metal evaporation. However, the desiccant film has a thickness of several tens to hundreds of nanometers, and hence is insufficient in moisture absorption capacity in order to be used over a long period. In addition, when the vacuum deposition process is used for forming the thin film, high-temperature heating is necessary, and therefore a transparent resin, film or the like cannot be used as a protection film or a seal plate.

### Patent Document 1: Japanese Unexamined Patent Publication 1997-148066

### Patent Document 2: Japanese Unexamined Patent Publication 2003-142256

### Patent Document 3: Japanese Unexamined Patent Publication 2003-338366

### DISCLOSURE OF THE INVENTION

### Problem to be Solved by the Invention

A principal object of the present invention is to provide a transparent desiccant with a high moisture absorption capacity which is suitable for use as a desiccant for organic EL devices (especially top-emitting organic EL devices).

### Means for Solving the Problem

The present inventors conducted extensive research in order to achieve the aforementioned object. As a result, it was found that the object can be achieved by using a specific organometallic compound obtained by reacting a metal alkoxide with a polyol. The present invention was accomplished based on this finding.

The invention relates to transparent desiccants as itemized below.

1. A transparent desiccant comprising an organometallic compound obtained by reacting a metal alkoxide with a polyol.

2. A transparent desiccant according to Item 1, wherein the metal alkoxide is a compound represented by general formula (1) shown below:

M(OR¹)ₐ (1)

wherein M is a group II element, a group III element or a group IV element; R¹ is a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents; and a is an integer of 2 when M is a group II element, an integer of 3 when M is a group III element, and an integer of 4 when M is a group IV element, and wherein the polyol is a compound represented by general formula (2) shown below:

HO-Z-OH (2)

wherein Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group.

3. A transparent desiccant according to Item 1 or 2, comprising an organometallic compound represented by general formula (3) shown below:

(R¹O)_{b}M(OZOH)_{c} (3)

wherein M is a group II element, a group III element or a group IV element; R¹ is a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents; Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group; b is an integer from 0 to 2; c is an integer from 1 to 4; and b+c is 2 when M is a group II element, 3 when M is a group III element, and 4 when M is a group IV element.

4. A transparent desiccant according to Item 1 or 2, comprising an organometallic compound represented by general formula (4) shown below:

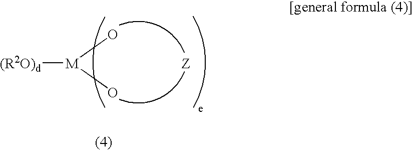

wherein M is a group II element, group III element or a group IV element; Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group; R² is a monovalent open-chain hydrocarbon group which may be substituted with one or more substituents, a monovalent alicyclic hydrocarbon group which may be substituted with one or more substituents, a monovalent monocyclic or polycyclic aromatic or heteroaromatic hydrocarbon group which may be substituted with one or more substituents, or a -ZOM(OZO) group where Z and M are the same as above; d is an integer from 0 to 2; e is an integer of 1 or 2; and d+e is 1 when M is a group II element, 2 when M is a group III element, and 2 or 3 when M is a group IV element.

5. A transparent desiccant according to Item 1 or 2, comprising an organometallic compound represented by general formula (5) shown below:

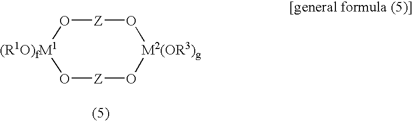

wherein M¹ and M² are the same or different, each being a group II element, a group III element or a group IV element; R¹ and R³ are the same or different, each being a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents; Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group; f and g are each independently 0 when M¹ or M² is a group II element, 1 when M¹ or M² is a group III element, and 2 when M¹ or M² is a group IV element.

6. A transparent desiccant according to any one of Items 2 to 5, wherein the group II element is at least one element selected from the group consisting of Mg and Ca; the group III element is at least one element selected from the group consisting of B, Al and Ga; and the group IV element is at least one element selected from the group consisting of Si, Sn, Ti and Zr.

7. A transparent desiccant comprising a condensate obtained by condensing the organometallic compound according to any of Items 1 to 6 by a heat treatment.

8. A transparent desiccant according to any one of Items 1 to 7 for use in an organic EL device.

Transparent desiccants in, accordance with the present invention are described in detail below.

A transparent desiccant in accordance with the invention comprises an organometallic compound obtained by reacting a metal alkoxide with a polyol.

The kinds of metal alkoxide and polyol are not limited, so long as the resulting organometallic compound exhibits sufficient hygroscopicity and transparency as a transparent desiccant.

A preferable metal alkoxide is a compound represented by general formula (1) shown below:

M(OR¹)ₐ (1)

wherein M is a group II element, a group III element or a group IV element; R¹ is a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents; and a is an integer of 2 when M is a group II element, an integer of 3 when M is a group III element, and an integer of 4 when M is a group IV element.

M may be a group II element, a group III element or a group IV element. Examples of group II elements include Be, Mg, Ca, Sr and Ba. Among these examples, at least one element of Mg and Ca is preferable.

Examples of group III elements include B, Al, Ga and In. Among these examples, at least one element of B, Al and Ga is preferable.

Examples of group IV elements include Si, Ge, Sn, Ti, Zr, Pb and Hf. Among these examples, at least one element of Si, Sn, Ti and Zr is preferable.

R¹ represents a monovalent open-chain hydrocarbon group which may be substituted with one or more substituents; a monovalent alicyclic hydrocarbon group which may be substituted with one or more substituents; or a monovalent monocyclic or polycyclic aromatic or heteroaromatic hydrocarbon group which may be substituted with one or more substituents.

Examples of monovalent open-chain hydrocarbon groups include methyl, ethyl, n-propyl, isopropyl, n-butyl, sec-butyl, isobutyl, tert-butyl, pentyl, 2-ethylhexyl, dodecyl, octadecyl, vinyl, allyl, 9-octadecenyl, and the like.

Examples of monovalent alicyclic hydrocarbon groups include cyclopentyl, cyclohexyl, and the like.

Examples of monovalent monocyclic or polycyclic aromatic or heteroaromatic hydrocarbon groups include phenyl, 2-methylphenyl, 1-naphthyl, biphenyl, 4-pyridyl, 6-quinolinyl, 2-carbazolyl and the like.

When M is a group II element, a represents an integer of 2; when M is a group III element, a represents an integer of 3; and when M is a group IV element, a represents an integer of 4.

Among metal alkoxides represented by general formula (1), open-chain hydrocarbon groups having 1 to 8 carbon atoms are particularly preferable; specific examples include triethoxyaluminum, triisopropoxyaluminum, tri(n-butoxy)aluminum, tri(sec-butoxy)aluminum, trimethoxyboron, triethoxyboron, tetramethoxysilane, tetraethoxysilane, tetra(n-butoxy)silane, tetra(n-butoxy)titanium, tetra(n-butoxy)zirconium, triethoxygallium, triisopropoxygallium, tri(n-butoxy)gallium, tri(sec-butoxy)gallium, tetraethoxytin, tetra(isopropoxy)tin, tetra(n-butoxy) tin, tetra(sec-butoxy) tin, etc.

A preferable polyol is a compound represented by general formula (2) shown below:

HO-Z-OH (2)

wherein Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group.

Z represents a divalent open-chain hydrocarbon group which may be substituted with one or more substituents; a divalent alicyclic hydrocarbon group which may be substituted with one or more substituents; a divalent monocyclic or polycyclic aromatic or heteroaromatic hydrocarbon group which may be substituted with one or more substituents; an oxyalkylene group; or an iminoalkylene group.

Examples of divalent open-chain hydrocarbon groups include ethylene, 1,2-propanediyl, 1,3-propanediyl, 1,3-butanediyl, 2,3-butanediyl, 1,4-butanediyl, 1,6-hexanediyl, 2,2-dimethyl-1,3-propanediyl, 2-butyl-2-ethyl-1,3-propanediyl, 2,3-dimethyl-2,3-butanediyl, 2-methyl-2,4-pentanediyl, 2-methyl-1,3-hexanediyl, 1,2-diphenyl-1,2-ethanediyl, 2-butene-1,4-diyl, 2,4,7,9-tetramethyl-5-decene-4,7-diyl, 2-hydroxy-1,3-propanediyl, 2-ethyl-2-hydroxymethyl-1,3-propanediyl, 2,2-di(hydroxymethyl)-1,3-propanediyl, etc.

Examples of divalent alicyclic hydrocarbon groups include 1,2-cyclohexanediyl, 1,4-cyclohexanediyl, etc.

Examples of divalent monocyclic or polycyclic aromatic or heteroaromatic hydrocarbon groups include 1,2-phenylene, 1,4-phenylene, 2-methyl-1,4-phenylene, naphthalene-2,3-diyl, 2,2-diphenylpropane-4,4′-diyl, 2,3-pyridyl, etc.

Examples of oxyalkylene groups include —CH₂CH₂OCH₂CH₂—, —CH₂CH₂OCH₂CH₂OCH₂CH₂—, —CH(CH₃)CH₂OCH₂(CH₃)CH—, —CH(CH₃)CH₂OCH(CH₃)CH₂OCH₂(CH₃)CH—, etc.

Examples of iminoalkylene groups include —CH₂CH₂NHCH₂CH₂—, —CH₂CH₂N(CH₃)CH₂CH₂—, —CH₂CH₂N(CH₂CH₂OH)CH₂CH₂—, etc.

The kind of substituent(s) which may be introduced to Z is not limited, but hydroxyl group(s) (—OH) are preferable.

Among polyols represented by general formula (2), at least one of open-chain polyols, alicyclic polyols, aromatic or heteroaromatic polyols, polyoxyalkyleneglycols and polyalkanolamines is especially preferable. Specific examples are as follows.

Examples of open-chain polyols include ethylene glycol, 1,2-propanediol, 1,3-propanediol, 1,3-butanediol, 2,3-butanediol, 1,4-butanediol, 1,6-hexanediol, 2,2-dimethyl-1,3-propanediol, 2-butyl-2-ethyl-1,3-propanediol, 2,3-dimethyl-2,3-butanediol, 2-methyl-2,4-pentanediol, 2-methyl-1,3-hexanediol, 1,2-diphenyl-1,2-ethanediol, 2-butene-1,4-diol, 2,4,7,9-tetramethyl-5-decene-4,7-diol, glycerol, trimethylolpropane, pentaerythritol, etc.

Examples of alicyclic polyols include 1,2-cyclohexanediol, 1,4-cyclohexanediol, etc.

Examples of aromatic or heteroaromatic polyols include catechol, hydroquinone, 2-methylhydroquinone, 2,3-dihydroxynaphthalene, 2,2-bis(4,4′-dihydroxyphenyl)propane, 2,3-dihydroxypyridine, etc.

Examples of polyoxyalkyleneglycols include diethylene glycol, triethylene glycol, polyethylene glycol, dipropylene glycol, tripropylene glycol, polypropylene glycol, etc.

Examples of polyalkanolamines include diethanolamine, N-methyldiethanolamine, triethanolamine, etc.

The method of reacting a metal alkoxide with a polyol for the preparation of the organometallic compound is not limited. For example, reaction can be carried out by any of the following methods:

(1) reacting a metal alkoxide with a polyol (which may be a mixture of two or more polyols, likewise below);

(2) reacting a mixture of two or more metal alkoxides with a polyol;

(3) further reacting the organometallic compound obtained from reaction (1) above with a further metal alkoxide used in the reaction (1); and

(4) further reacting the organometallic compound obtained from reaction (1) above with a metal alkoxide different from the metal alkoxide used in the reaction (1).

Reactions (1) to (4) above may be carried out in a suitable solvent (for example, toluene, etc.). Although the ambient atmosphere of the mixture of starting materials is not limited, an inert atmosphere is generally preferable; for example, the inside of the reaction vessel is preferably a nitrogen atmosphere. If the reaction does not easily proceed merely by mixing a metal alkoxide with polyol, heating may be suitably conducted to promote the reaction. The proportion of the metal alkoxide to polyol is not particularly limited; it may be suitably adjusted according to the kind of target organometallic compound.

The following are specific examples of organometallic compounds in accordance with the present invention prepared by reacting metal alkoxides with polyols.

For example, organometallic compounds represented by general formula (3) shown below:

(R¹O)_{b}M(OZOH)_{c} (3)

wherein M is a group II element, a group III element or a group IV element; R¹ is a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents; Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group; b is an integer from 0 to 2; c is an integer from 1 to 4; and b+c is 2 when M is a group II element, 3 when M is a group III element, and 4 when M is a group IV element.

In general formula (3), R¹, M and Z are the same as above; b is an integer from 0 to 2; c is an integer from 1 to 4; and b+c is 2 when M is a group II element, 3 when M is a group III element, and 4 when M is a group IV element.

Specific examples of the organometallic compounds represented by general formula (3) include the compound represented by the estimated structure shown below:

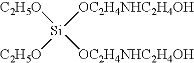

The organometallic compound represented by this estimated structure can be synthesized by, for example, the process described in Synthesis Example 3 below. More specifically, this organometallic compound can be synthesized by reacting tetraethoxysilane (a metal alkoxide) with diethanolamine (a polyol) in accordance with reaction method (1) mentioned above.

Examples of organometallic compounds in accordance with the invention also include compounds represented by general formula (4) shown below:

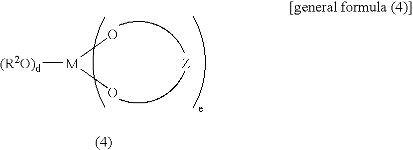

wherein M is a group II element, group III element or a group IV element; Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group; R² is a monovalent open-chain hydrocarbon group which may be substituted with one or more substituents, a monovalent alicyclic hydrocarbon group which may be substituted with one or more substituents, a monovalent monocyclic or polycyclic aromatic or heteroaromatic hydrocarbon group which may be substituted with one or more substituents, or a -ZOM(OZO) group where Z and M are the same as above; d is an integer from 0 to 2; e is an integer of 1 or 2; and d+e is 1 when M is a group II element, 2 when M is a group III element, and 2 or 3 when M is a group IV element.

In general formula (4), M and Z are the same as above; R² is a monovalent open-chain hydrocarbon group which may be substituted with one or more substituents, a monovalent alicyclic hydrocarbon group which may be substituted with one or more substituents, a monovalent monocyclic or polycyclic aromatic or heteroaromatic hydrocarbon group which may be substituted with one or more substituents, or a -ZOM(OZO) group where Z and M are the same as above; examples of groups for R² are as described above; d is an integer from 0 to 2; e is an integer of 1 or 2; and d+e is 1 when M is a group II element, 2 when M is a group III element, and 2 or 3 when M is a group IV element.

Specific examples of organometallic compounds represented by general formula (4) include those represented by the two estimated structures shown below:

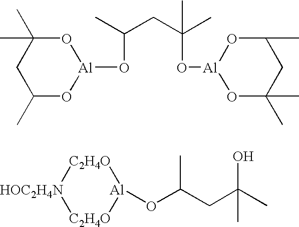

The organometallic compound represented by the former estimated structure can be synthesized by, for example, the process of Synthesis Example 1 described below. More specifically, this organometallic compound can be synthesized by reacting triisopropoxyaluminum (a metal alkoxide) with 2-methyl-2,4-pentanediol (a polyol) in accordance with reaction method (1) mentioned above.

The organometallic compound represented by the latter estimated structure can be synthesized by, for example, the process of Synthesis Example 2 described below. More specifically, this organometallic compound can be synthesized by reacting a mixture of 2-methyl-2,4-pentanediol and triethanolamine (polyols) with triisopropoxyaluminum (a metal alkoxide) in accordance with reaction method (1) shown above.

Examples of organometallic compounds in accordance with the invention further include those represented by general formula (5) shown below:

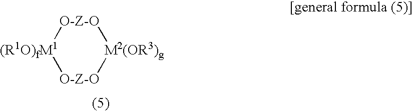

wherein M¹ and M² are the same or different, each being a group II element, a group III element or a group IV element; R¹ and R³ are the same or different, each being a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents; Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group; f and g are each independently 0 when M¹ or M² is a group II element, 1 when M¹ or M² is a group III element, and 2 when M¹ or M² is a group IV element.

In general formula (5), M¹ and M² are the same or different, each being a group II element, a group III element or a group IV element; examples of the group II element, group III element and group IV element are as described above; R¹ and R³ are the same or different, each being a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents; examples of groups for R¹ and R³ are as described above; Z is the same as above; and f and g are each independently 0 when M¹ or M² is a group II element, 1 when M¹ or M² is a group III element, and 2 when M¹ or M² is a group IV element.

Specific examples of organometallic compounds represented by general formula (5) include those represented by the six estimated structures shown below:

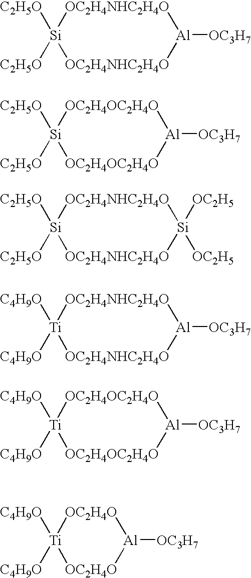

Among the six kinds of organometallic compounds shown above, the organometallic compound represented by the first estimated structure can be synthesized by the process described in Synthesis Example 4 below. More specifically, this organometallic compound can be synthesized by reacting the reaction product of tetraethoxysilane and diethanolamine (i.e., the organometallic compound obtained in Synthesis Example 3) with triisopropoxyaluminum (a metal alkoxide) in accordance with reaction method (4) shown above.

The organometallic compound represented by the second estimated structure can be synthesized by, for example, the process described in Synthesis Example 5 below. More specifically, this organometallic compound can be synthesized by reacting the reaction product of tetraethoxysilane and diethylene glycol with triisopropoxyaluminum (a metal alkoxide) in accordance with reaction method (4) shown above.

The organometallic compound represented by the third estimated structure can be synthesized by, for example, the process described in Synthesis Example 6 below. More specifically, this organometallic compound can be synthesized by reacting the reaction product of tetraethoxysilane and diethanolamine with tetraethoxysilane (a metal alkoxide) in accordance with reaction method (3) shown above.

The organometallic compound represented by the fourth estimated structure can be synthesized by, for example, the process described in Synthesis Example 7 below. More specifically, this organometallic compound can be synthesized by reacting the reaction product of tetra(n-butoxy)titanium and diethanolamine with triisopropoxyaluminum (a metal alkoxide) in accordance with reaction method (4) shown above.

The organometallic compound represented by the fifth estimated structure can be synthesized by, for example, the process described in Synthesis Example 8 below. More specifically, this organometallic compound can be synthesized by reacting the reaction product of tetra(n-butoxy)titanium and diethylene glycol with triisopropoxyaluminum (a metal alkoxide) in accordance with reaction method (4) shown above.

The organometallic compound represented by the sixth estimated structure can be synthesized by, for example, the process described in Synthesis Example 9 below. More specifically, this organometallic compound can be synthesized by reacting the reaction product of tetra(n-butoxy)titanium and ethylene glycol with triisopropoxyaluminum (a metal alkoxide) in accordance with reaction method (4) shown above.

Moreover, examples of organometallic compounds in accordance with the invention include those in which the repeating units represented by general formula (6) shown below are connected randomly or in block form:

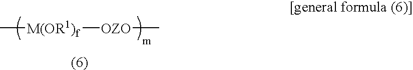

wherein M, R¹, Z and f are each an element, group or integer as above; and m is an integer from 1 to 100.

In such organometallic compounds containing the repeating units connected randomly or in block form, two or more kinds of each M, R¹, f and Z may be the same or different.

Examples of such organometallic compounds containing repeating units connected randomly or in block form include those represented by the two estimated structures as shown below:

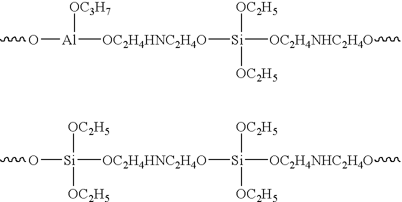

Alternatively, the organometallic compound of the invention may be at least one compound selected from the group consisting of compounds represented by general formulae (I) and (III) to (VIII):

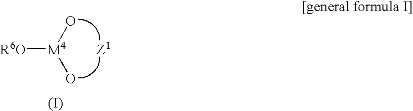

wherein M⁴ is a group III element; R⁶ is a monovalent open-chain hydrocarbon group which may be substituted with one or more substituents, a monovalent alicyclic hydrocarbon group which may be substituted with one or more substituents, a monovalent monocyclic or polycyclic aromatic or heteroaromatic hydrocarbon group which may be substituted with one or more substituents, or a group represented by general formula (II) shown below; and Z¹ is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group;

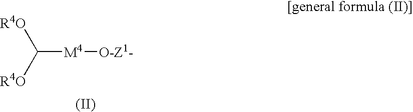

wherein M⁴ is the same as above, and may be the same as or different from M⁴ in general formula (I); Z¹ is the same as above, and may be the same as or different from Z¹ in general formula (I); and R⁴ may be the same or different, or taken together may form a group represented by Z¹, and is each a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents;

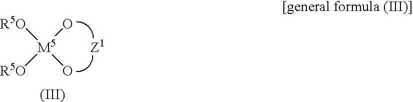

wherein M⁵ is a group IV element; R⁵ may be the same or different, each being a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents; and Z¹ is the same as the above;

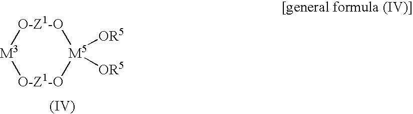

wherein M⁵ is the same as above; M³ is a group II element; Z¹ is the same as above, and each may be the same or different; and R⁵ is the same as above, and each may be the same or different;

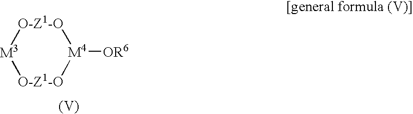

wherein M⁴, M³, Z¹ and R⁶ are the same as above, and each Z¹ may be the same or different;

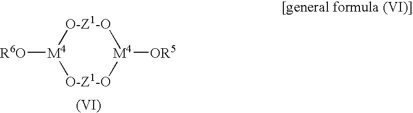

wherein M⁴, Z¹, R⁶ and R⁵ are the same as above; each M⁴ may be the same or different; and each Z¹ may be the same or different;

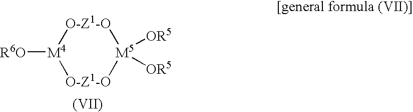

wherein M⁴, M⁵, Z¹, R⁶ and R⁵ are each the same as above; each Z¹ may be the same or different; and each R⁵ may be the same or different; and

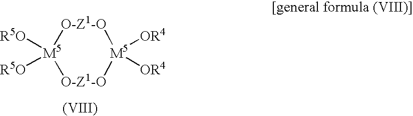

wherein M⁵, Z¹, R⁴ and R⁵ are each the same as above; each M⁵ may be the same or different; each Z¹ may be the same or different; each R⁴ may be the same or different; and each R⁵ may be the same or different.

In general formula (I), M⁴ is a group III element. Examples of group III elements include B, Al, Ga and In. Among these elements, at least one of B, Al and Ga is preferable.

R⁶ is a monovalent open-chain hydrocarbon group which may be substituted with one or more substituents, a monovalent alicyclic hydrocarbon group which may be substituted with one or more substituents, a monovalent monocyclic or polycyclic aromatic or heteroaromatic hydrocarbon group which may be substituted with one or more substituents, or a group represented by general formula (II).

Examples of monovalent open-chain hydrocarbon groups include methyl, ethyl, n-propyl, isopropyl, n-butyl, sec-butyl, isobutyl, tert-butyl, pentyl, 2-ethylhexyl, dodecyl, octadecyl, vinyl, allyl, 9-octadecenyl, and the like.

Examples of monovalent alicyclic hydrocarbon groups include cyclopentyl, cyclohexyl, and the like.

Examples of monovalent monocyclic or polycyclic aromatic or heteroaromatic hydrocarbon groups include phenyl, 2-methylphenyl, 1-naphthyl, biphenyl, 4-pyridyl, 6-quinolinyl, 2-carbazolyl, and the like.

Groups represented by general formula (II) will be described later.

Z¹ is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group.

Examples of divalent open-chain hydrocarbon groups include ethylene, 1,2-propanediyl, 1,3-propanediyl, 1,3-butanediyl, 2,3-butanediyl, 1,4-butanediyl, 1,6-hexanediyl, 2,2-dimethyl-1,3-propanediyl, 2-butyl-2-ethyl-1,3-propanediyl, 2,3-dimethyl-2,3-butanediyl, 2-methyl-2,4-pentanediyl, 2-methyl-1,3-hexanediyl, 1,2-diphenyl-1,2-ethanediyl, 2-butene-1,4-diyl, 2,4,7,9-tetramethyl-5-decene-4,7-diyl, 2-hydroxy-1,3-propanediyl, 2-ethyl-2-hydroxymethyl-1,3-propanediyl, 2,2-di(hydroxymethyl)-1,3-propanediyl, etc.

Examples of divalent alicyclic hydrocarbon groups include 1,2-cyclohexanediyl, 1,4-cyclohexanediyl, etc.

Examples of divalent monocyclic or polycyclic aromatic or heteroaromatic hydrocarbon groups include 1,2-phenylene, 1,4-phenylene, 2-methyl-1,4-phenylene, naphthalene-2,3-diyl, 2,2-diphenylpropane-4,4′-diyl, 2,3-pyridyl, etc.

Examples of oxyalkylene groups include —CH₂CH₂OCH₂CH₂—, —CH₂CH₂OCH₂CH₂OCH₂CH₂—, —CH(CH₃)CH₂OCH₂ (CH₃)CH—, —CH(CH₃)CH₂OCH(CH₃)CH₂OCH₂(CH₃)CH—, etc.

Examples of iminoalkylene groups include —CH₂CH₂NHCH₂CH₂—, —CH₂CH₂N(CH₃)CH₂CH₂—, —CH₂CH₂N(CH₂CH₂OH)CH₂CH₂—, etc.

The kind of substituent(s) which may be introduced to Z¹ is not limited, but hydroxyl group(s) (—OH) are preferable.

In organometallic compounds represented by general formula (I), R⁶ may be a group represented by general formula (II) shown below:

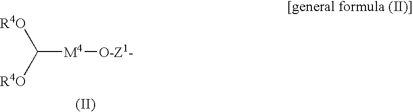

wherein M⁴ is the same as above, and may be the same as or different from M⁴ in general formula (I); Z¹ is the same as above, and may be the same as or different from Z¹ in general formula (I); and R⁴ may be the same or different, or taken together may form a group represented by Z¹, and are each a monovalent open-chain hydrocarbon group which may be substituted with one or more substituents group, a monovalent alicyclic hydrocarbon group which may be substituted with one or more substituents, or a monovalent monocyclic or polycyclic aromatic or heteroaromatic hydrocarbon group which may be substituted with one or more substituents.

Organometallic compounds represented by general formula (III) are represented by the formula shown below:

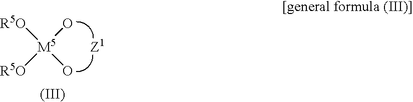

In general formula (III), M⁵ is a group IV element. Examples of group IV elements include Si, Ge, Sn, Ti, Zr, Pb and Hf. Among these, at least one of Si, Sn, Ti and Zr is preferable.

In general formula (III), R⁵ is a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents. Monovalent open-chain hydrocarbon groups which may be substituted with one or more substituents, monovalent alicyclic hydrocarbon groups which may be substituted with one or more substituents, and monovalent monocyclic or polycyclic aromatic or heteroaromatic hydrocarbon groups which may be substituted with one or more substituents are the same as those previously described. Each R⁵ may be the same or different, and Z¹ is the same as above.

Organometallic compounds represented by general formula (IV) are represented by the formula shown below:

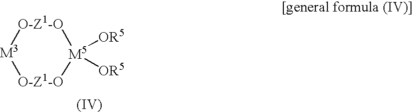

In general formula (IV), M⁵ is the same as above, and M³ is a group II element. Examples of group II elements include Be, Mg, Ca, Sr and Ba. Among these, at least one of Mg and Ca, in particular, is preferable.

Z¹ is the same as above, and each may be the same or different; R⁵ is the same as above, and each may be the same or different.

Organometallic compounds represented by general formula (V) are represented by the formula shown below:

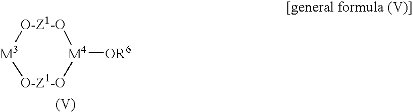

wherein M⁴, M³, Z¹ and R⁶ are each the same as above; examples of R⁶ include groups represented by general formula (II); and each Z¹ may be the same or different.

Organometallic compounds represented by general formula (VI) are represented by the formula shown below:

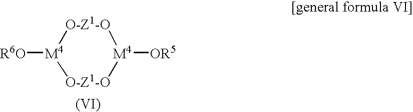

wherein M⁴, Z¹, R⁶ and R⁵ are each the same as above; examples of R⁶ include groups represented by general formula (II); each M⁴ may be the same or different; and each Z¹ may be the same or different.

Organometallic compounds represented by general formula (VII) are represented by the formula shown below:

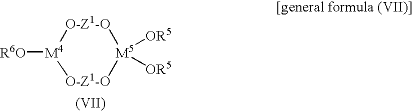

wherein M⁴, M⁵, Z¹, R⁶ and R⁵ are the same as above; examples of R⁶ include groups represented by general formula (II); each Z¹ may be the same or different; and each R⁵ may be the same or different.

Organometallic compounds represented by general formula (VIII) are represented by the formula shown below:

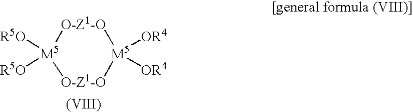

wherein M⁵, Z¹, R⁴ and R⁵ are each the same as above; each M⁵ may be the same or different; each Z¹ may be the same or different; each R⁴ may be the same or different; and each R⁵ may be the same or different.

In general formula (VIII), R⁴ taken together may form a group represented by Z¹; and Z¹ is the same as above.

The organometallic compounds of the present invention described above are especially suitable for use as transparent desiccants for organic EL devices.

For example, a transparent desiccant layer for an organic EL device can be formed by applying a liquid product prepared by dissolving any of such organometallic compounds in any of various solvents over a given organic EL device substrate, and then drying the liquid product.

The solvent is not particularly limited so long as the organometallic compound is highly soluble therein, and does not adversely affect the transparency of the desiccant layer; it may suitably be selected in accordance with the kind of organometallic compound. Examples of such solvents include alcohols, ketones, esters, ethers, petroleum-based solvents, etc. More specifically, ethylene glycol monobutyl ether, isopropyl alcohol (IPA), toluene and the like can be mentioned.

The viscosity of the liquid product is not particularly limited, so long as the liquid product can be easily applied. The concentration of the organometallic compound (weight % in the liquid) can be suitably selected from the range of 5 to 95 wt %.

The liquid product may be applied over a given substrate by any of a variety of processes, such as brushing, spin coating, ink-jet printing, screen printing, gravure printing, spraying, and other processes. The thickness of the coating film is not particularly limited, but is usually from 1 to 300 μm, and preferably from 5 to 100 μm (when dried). Coating and drying are preferably performed in a low humidity environment (for example, in a dry N₂ atmosphere, which is an inert atmosphere).

Although the conditions of drying after coating are not particularly limited, drying is preferably performed so as to sufficiently reduce the moisture content of the film. For example, the applied transparent desiccant layer may be dried at 50 to 300° C. for several minutes to several hours, and preferably at 100 to 200° C. for about 5 to about 30 minutes. When, in the drying process, not only the water content of the organometallic compound can be sufficiently reduced, but also a condensate of the organometallic compound can be formed, this will further enhance the moisture absorption capacity of the organometallic compound. When the organometallic compound is condensed, it is particularly preferable that the alkoxy and polyhydroxy groups of the organometallic compound remain in the condensate.

Although the dried desiccant film is transparent, it does not necessarily have to be colorless and transparent. For example, the dried desiccant film may be pale-yellow transparent, light dark-brown transparent, light-brown transparent, and light-blue transparent. The degree of transparency can be determined in accordance with the transparency standards prescribed under JIS-K 7105. The dried desiccant film preferably has a transparency such that the transmittance is 90% or higher.

The transparent desiccant layer thus obtained is excellent at absorbing moisture, and exhibits a stable moisture absorption ability over a long period. The transparent desiccant layer has excellent optical transparency, and hence is also suitable for use as a desiccant for a top-emitting organic EL device. In particular, owing to its high hygroscopicity, the transparent desiccant layer is capable of sufficiently preventing the formation of “darkspots”, which can cause degradation of the organic EL device performance.

### EFFECTS OF THE INVENTION

The transparent desiccant layer of the present invention is excellent at absorbing moisture, and exhibits a stable moisture absorption ability over a long period of time. The transparent desiccant layer has excellent optical transparency, and hence is also suitable for use as a desiccant for top-emitting organic EL devices. Particularly preferable organometallic compounds are those described in Examples 2 to 6.

### BRIEF DESCRIPTION OF THE DRAWINGS

FIG. 1 is a schematic diagram illustrating the structure of an organic EL device;

FIG. 2 is a schematic diagram illustrating the structure of a bottom-emitting organic EL device;

FIG. 3 is a schematic diagram illustrating the structure of a top-emitting organic EL device;

FIG. 4 is a graph showing a characteristic (i.e., relationship between time and weight increases of each desiccant) of the transparent desiccants prepared in Examples and Comparative Example;

FIG. 5 is a graph showing the moisture absorption abilities (i.e., relationship between time and the humidity in each encapsulated container) of the transparent desiccants prepared in Examples and Comparative Example; and

FIG. 6 shows the results of Experimental Examples 1 to 3.

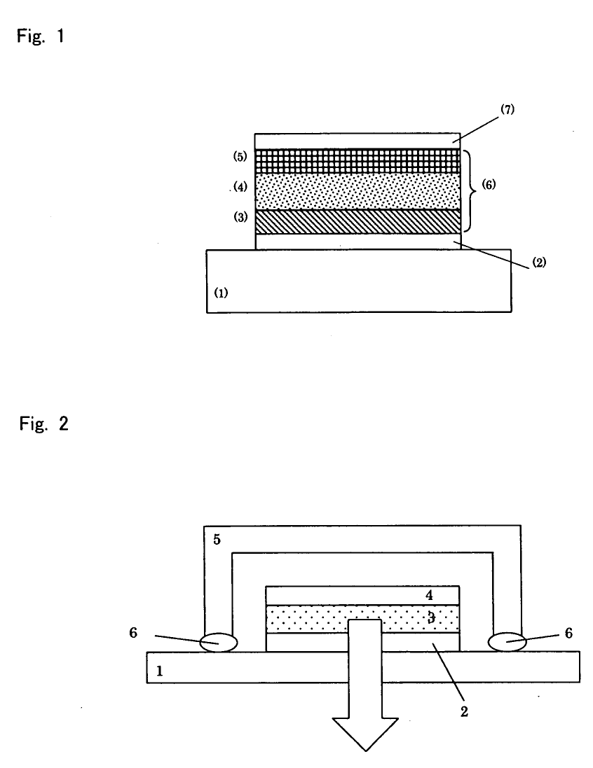

### EXPLANATION OF REFERENCE NUMERALS

(1) Glass substrate
(2) Anode
(3) Hole-transporting layer
(4) Light-emitting layer
(5) Electron-transporting layer
(6) Organic layer
(7) Cathode
1 Glass substrate
2 Anode (transparent electrode)
3 Organic layer
4 Cathode (opaque electrode)
5 Seal member
6 Seal material
1′ Glass substrate
2′ Anode (reflective electrode)
3′ Organic layer
4′ Cathode (transparent electrode)
5′ Seal member
6′ Seal material

### BEST MODE FOR CARRYING OUT THE INVENTION

The invention is described in further detail through the Examples and Comparative Example given below, which are not intended to limit the scope of the disclosure.

### Synthesis Example 1

### Synthesis of Organometallic Compound 1

In a 500-mL glass reactor were placed 128.24 g (0.63 mol) of triisopropoxyaluminum and 110.63 g of toluene. The reactor was purged with nitrogen, and the triisopropoxyaluminum was then dissolved with stirring at room temperature. To this solution was added dropwise 111.32 g (0.94 mol) of 2-methyl-2,4-pentanediol, and was refluxed with heating at 85 to 95° C. for 1 hour. Isopropyl alcohol and toluene were subsequently distilled from the reaction solution at 85 to 105° C. under normal pressure. Solvent was then removed at 85 to 90° C. under a reduced pressure of 69.9 kPa until hardly any distillate was produced. After cooling down to 50° C. or less, toluene was subsequently added to yield a 50.3% solution. The viscosity of the solution was 5 mPa·s.

The estimated structure of the resulting organometallic compound is as shown below:

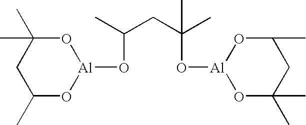

In order to confirm the formation of the target compound, the aluminum content and infrared absorption spectrum were measured. The results are shown below.

Aluminum content: 6.75% (theoretical value: 6.75%)

IR spectrum (cm⁻¹): 2969, 2905 (alkyl group C—H stretching vibration); 647, 541 (Al—O absorption bands)

### Synthesis Example 2

### Synthesis of Organometallic Compound 2

In a 500-mL glass reactor were placed 101.15 g (0.50 mol) of triisopropoxyaluminum and 80.18 g of toluene. The reactor was purged with nitrogen, and the triisopropoxyaluminum was then dissolved at room temperature. A mixture of 58.53 g (0.50 mol) of 2-methyl-2,4-pentanediol and 73.90 g (0.50 mol) of triethanolamine was subsequently added dropwise at 20 to 52° C. with stirring. After refluxing for 1 hour at 85 to 90° C., isopropyl alcohol was distilled from the reaction solution at 90 to 125° C. under normal pressure. Solvent was then removed at 30 to 61° C. under a reduced pressure of 1.3 kPa until hardly any distillate was produced. After cooling down to 50° C. or less, toluene was subsequently added to yield a 56.1% solution. The viscosity of the solution was 11 mPa·s.

The estimated structure of the resulting organometallic compound is as shown below:

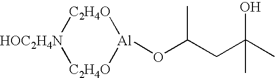

In order to confirm the formation of the target compound, the aluminum content and infrared absorption spectrum were measured. The results are shown below.

Aluminum content: 5.20% (theoretical value: 5.20%)

IR spectrum (cm⁻¹): 3350 (O—H stretching vibration); 2968, 2878 (alkyl group C—H stretching vibration); 674, 640, 608, 547 (Al—O absorption bands)

### Synthesis Example 3

### Synthesis of Organometallic Compound 3

In a 300-mL glass reactor were placed 76.55 g (0.37 mol) of tetraethoxysilane and 77.27 g (0.73 mol) of diethanolamine. The reactor was purged with nitrogen, and subsequently 33.9 g (0.74 mol) of ethanol was distilled off at 70 to 80° C. with stirring under reduced pressure, so as to give 119.05 g (0.36 mol) of a colorless liquid.

The estimated structure of the resulting organometallic compound is as shown below:

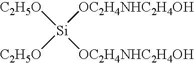

In order to confirm the formation of the target compound, the infrared absorption spectrum was measured. The results are shown below.

IR spectrum (cm⁻¹): 3287 (overlap of N—H stretching vibration and O—H stretching vibration); 2929, 2884 (alkyl group C—H stretching vibration); 1455 (alkyl group C—H deformation vibration); 1077 (C—O stretching vibration); 792 (Si—O stretching vibration)

### Synthesis Example 4

### Synthesis of Organometallic Compound 4

In a 200-mL glass reactor was placed 44.29 g (0.21 mol) of tetraethoxysilane. The reactor was purged with nitrogen, and 44.71 g (0.43 mol) of diethanolamine was then added dropwise at room temperature with stirring. After reacting the mixture at 64 to 77° C. for 1 hour, 19.6 g (0.43 mol) of ethanol was distilled off at 95 to 112° C. under normal pressure, thus giving 67.58 g (0.21 mol) of an intermediate.

In another 200-mL glass reactor was placed 39.02 g (0.19 mol) of triisopropoxyaluminum. The reactor was purged with nitrogen, and 62.39 g (0.19 mol) of the intermediate prepared above was then added dropwise at 30 to 47° C. with stirring. After refluxing at 90 to 100° C. for 2 hours, isopropyl alcohol solvent was removed at 60 to 80° C. under a reduced pressure of 6.8 kPa until hardly any distillate was produced. After cooling down to 50° C. or less, toluene was subsequently added to yield a 56.3% solution. The viscosity of the solution was 26 mPa·s.

The estimated structure of the resulting organometallic compound is as shown below:

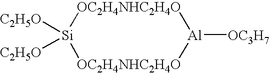

In order to confirm the formation of the target compound, the aluminum content and infrared absorption spectrum were measured. The results are shown below.

Aluminum content: 3.70% (theoretical value: 3.70%)

IR spectrum (cm⁻¹): 3391 (N—H stretching vibration); 2972, 2933, 2886 (alkyl group C—H stretching vibration); 1461 (alkyl group C—H deformation vibration); 605 (Al—O absorption bands)

### Synthesis Example 5

### Synthesis of Organometallic Compound 5

In a 300-mL glass reactor were placed 60.00 g (0.29 mol) of tetraethoxysilane and 61.13 g (0.58 mol) of diethylene glycol. The reactor was purged with nitrogen, and then reaction was carried out at 70° C., with stirring, for 30 minutes, so as to produce 121.28 g of an intermediate ethanol solution (concentration: 78.0%, 0.29 mol).

In another 300-mL glass reactor was placed 48.30 g (0.24 mol) of triisopropoxyaluminum. The reactor was purged with nitrogen, and 99.58 g of the intermediate ethanol solution prepared above (concentration: 78.0%, 0.24 mol) was then added dropwise at 50 to 60° C. After reacting at 80° C. for 1 hour, isopropyl alcohol was distilled off at 70 to 80° C. under reduced pressure until hardly any distillate was produced. Toluene was subsequently added to yield a 54.4% solution. The viscosity of the solution was 5 mPa·s.

The estimated structure of the resulting organometallic compound is as shown below.

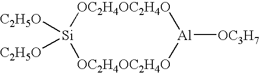

In order to confirm the formation of the target compound, the aluminum content and infrared absorption spectrum were measured. The results are shown below.

Aluminum content: 3.56% (Theoretical value: 3.56%)

IR spectrum (cm⁻¹): 2972, 2929, 2883 (alkyl group C—H stretching vibration); 1456 (alkyl group C—H deformation vibration); 1150 to 1100 (C—O—C stretching vibration); 1081 (C—O stretching vibration); 789 (Si—O stretching vibration); 644, 596, 555 (Al—O absorption bands)

### Synthesis Example 6

### Synthesis of Organometallic Compound 6

In a 300-mL glass reactor were placed 76.55 g (0.37 mol) of tetraethoxysilane and 77.27 g (0.73 mol) of diethanolamine. The reactor was purged with nitrogen, and then 33.9 g (0.74 mol) of ethanol was distilled off at 70 to 80° C. with stirring under reduced pressure, so as to give 119.05 g (0.36 mol) of an intermediate.

In another 300-mL glass reactor was placed 45.40 g (0.22 mol) of tetraethoxysilane. The reactor was purged with nitrogen, and then 71.15 g (0.22 mol) of the intermediate prepared above was added dropwise with stirring at room temperature. After reacting at 70° C. for 30 minutes, ethanol was distilled off at 70° C. under reduced pressure until hardly any distillate was produced.

The estimated structure of the resulting organometallic compound is as shown below:

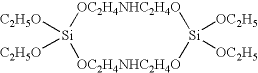

In order to confirm the formation of the target compound, the infrared absorption spectrum were measured. The results are shown below.

IR spectrum (cm⁻¹): 3304 (N—H stretching vibration); 2974, 2930, 2886 (alkyl group C—H stretching vibration); 1457 (alkyl group C—H deformation vibration); 1166 (C—N stretching vibration); 1078 (C—O stretching vibration); 791 (Si—O stretching vibration); 630, 599 (Al—O absorption bands)

### Synthesis Example 7

### Synthesis of Organometallic Compound 7

In a 300-mL glass reactor was placed 74.98 g (0.22 mol) of tetra(n-butoxy)titanium. The reactor was purged with nitrogen, and then 46.33 g (0.44 mol) of diethanolamine was added dropwise at 25 to 50° C. with stirring. Reaction was carried out at 30° C. for 15 minutes, so as to give 121.14 g of an intermediate butanol solution (concentration: 73.2%, 0.22 mol).

In another 300-mL glass reactor was placed 38.23 g (0.19 mol) of triisopropoxyaluminum. The reactor was purged with nitrogen, and then 102.89 g of the intermediate butanol solution prepared above (concentration: 73.2%, 0.19 mol) was added dropwise at 50 to 60° C. with stirring. After reacting at 85° C. for 30 minutes, byproduct alcohol was distilled off at 70 to 85° C. under reduced pressure until hardly any distillate was produced. Toluene was subsequently added to yield a 46.7% solution. The viscosity of the solution was 5 mPa·s.

The estimated structure of the resulting organometallic compound is as shown below:

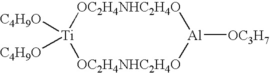

In order to confirm the formation of the target compound, the aluminum content and infrared absorption spectrum were measured. The results are shown below.

Aluminum content: 2.59% (theoretical value: 2.59%)

IR spectrum (cm⁻¹): 3203 (N—H stretching vibration); 2957, 2927, 2867 (alkyl group C—H stretching vibration); 1459 (alkyl group C—H deformation vibration); 1117 (C—N stretching vibration); 1066 (C—O stretching vibration); 680, 606, 514 (Al—O and Ti—O absorption bands)

### Synthesis Example 8

### Synthesis of Organometallic Compound 8

In a 300-mL glass reactor was placed 80.48 g (0.24 mol) of tetra(n-butoxy)titanium. The reactor was purged with nitrogen, and then 50.19 g (0.47 mol) of diethylene glycol was added dropwise at room temperature with stirring.

After heating to 80° C., 14.1 g of butanol was distilled off at 65 to 80° C. under reduced pressure for concentration, thus giving 116.40 g of an intermediate butanol solution (concentration: 82.1%, 0.24 mol). In another 300-mL glass reactor was placed 41.91 g (0.21 mol) of triisopropoxyaluminum. The reactor was purged with nitrogen, and 101.06 g of the intermediate butanol solution prepared above (concentration: 82.1%, 0.21 mol) was then added dropwise at 55 to 65° C. with stirring. After reacting at 80° C. for 30 minutes, byproduct alcohol was distilled off at 60 to 75° C. under reduced pressure until hardly any distillate was produced. Toluene was subsequently added to yield a 49.1% solution. The viscosity of the solution was 4 mPa·s.

The estimated structure of the resulting organometallic compound is as shown below:

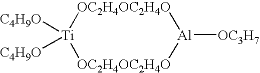

In order to confirm the formation of the target compound, the aluminum content and infrared absorption spectrum were measured. The results are shown below.

Aluminum content: 2.71% (theoretical value: 2.71%)

IR spectrum (cm⁻¹): 2958, 2926, 2862 (alkyl group C—H stretching vibration); 1462 (alkyl group C—H deformation vibration); 1144 (C—O—C stretching vibration); 1068 (C—O stretching vibration); 680, 634, 652 (Al—O and Ti—O absorption bands)

### Synthesis Example 9

### Synthesis of Organometallic Compound 9

In a 300-mL glass reactor was placed 93.16 g (0.27 mol) of tetra(n-butoxy)titanium. The reactor was purged with nitrogen, and then 32.89 g (0.55 mol) of ethylene glycol was added dropwise at 25 to 45° C. with stirring. After reacting at 35° C. for 20 minutes, 126.05 g of an intermediate butanol solution (concentration: 67.8%, 0.27 mol) was produced.

In another 300-mL glass reactor was placed 47.44 g (0.23 mol) of triisopropoxyaluminum. The reactor was purged with nitrogen, and 106.97 g of the intermediate butanol solution prepared above (concentration: 67.8%, 0.23 mol) was then added dropwise at 45 to 55° C. with stirring. After reacting at 85° C. for 30 minutes, byproduct alcohol was distilled off at 70 to 85° C. under reduced pressure until hardly any distillate was produced. Toluene was subsequently added to yield a 44.5% solution. The viscosity of the solution was 10 mPa·s.

The estimated structure of the resulting organometallic compound is as shown below:

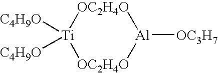

In order to confirm the formation of the target compound, the aluminum content and infrared absorption spectrum were measured. The results are shown below.

Aluminum content: 3.03% (theoretical value: 3.03%)

IR spectrum (cm⁻¹): 2958, 2931, 2870 (alkyl group C—H stretching vibration); 1463 (alkyl group C—H deformation vibration); 1085 (C—O stretching vibration); 645, 601 (Al—O and Ti—O absorption bands)

### Examples 1 to 9 and Comparative Example 1

Organometallic compounds used in Examples 1 to 9 and Comparative Example 1 are shown in Table 1 below.

TABLE 1

| | Organometallic Compound |
|---|---|
| Example 1 | Organometallic Compound 1 |
| Example 2 | Organometallic Compound 2 |
| Example 3 | Organometallic Compound 3 |
| Example 4 | Organometallic Compound 4 |
| Example 5 | Organometallic Compound 5 |
| Example 6 | Organometallic Compound 6 |
| Example 7 | Organometallic Compound 7 |
| Example 8 | Organometallic Compound 8 |
| Example 9 | Organometallic Compound 9 |
| Comparative Example 1 | aluminum oxide octylate produced by Hope |
| | Chemical Co., LTD |
| | Trade Name: OLIPE AOO |

The concentration, viscosity and appearance of each solution are shown in Table 2.

TABLE 2

| | Concentration | Viscosity | |
|---|---|---|---|
| | (%) | (mPa · s) | Appearance |
| Example 1 | 50.3 | 5 | Transparent |
| | | | pale red |
| Example 2 | 56.1 | 11 | Transparent |
| | | | yellow |
| Example 3 | 50.0 | 7 | Colorless and |
| | | | transparent |
| Example 4 | 56.3 | 26 | Colorless and |
| | | | transparent |
| Example 5 | 54.4 | 5 | Transparent |
| | | | pale yellow |
| Example 6 | 50.0 | 5 | Colorless and |
| | | | transparent |
| Example 7 | 46.7 | 5 | Transparent |
| | | | yellow |
| Example 8 | 49.1 | 4 | Transparent |
| | | | pale yellow |
| Example 9 | 44.5 | 10 | Transparent |
| | | | pale yellow |
| Comparative | 60.0 | 31 | Transparent |
| Example 1 | | | pale yellow |

The solutions shown above were each applied over the surface of a 5×5 cm glass in a dry N₂ environment with a spin coater.

This was followed by heating and drying with a hotplate in the same environment at 200° C. for 10 minutes, thus yielding transparent desiccant thin films having a thickness of about 10 μm.

The hygroscopicity of each of the resulting samples was subsequently evaluated by measurement at 20° C. and a humidity of 65% RH.

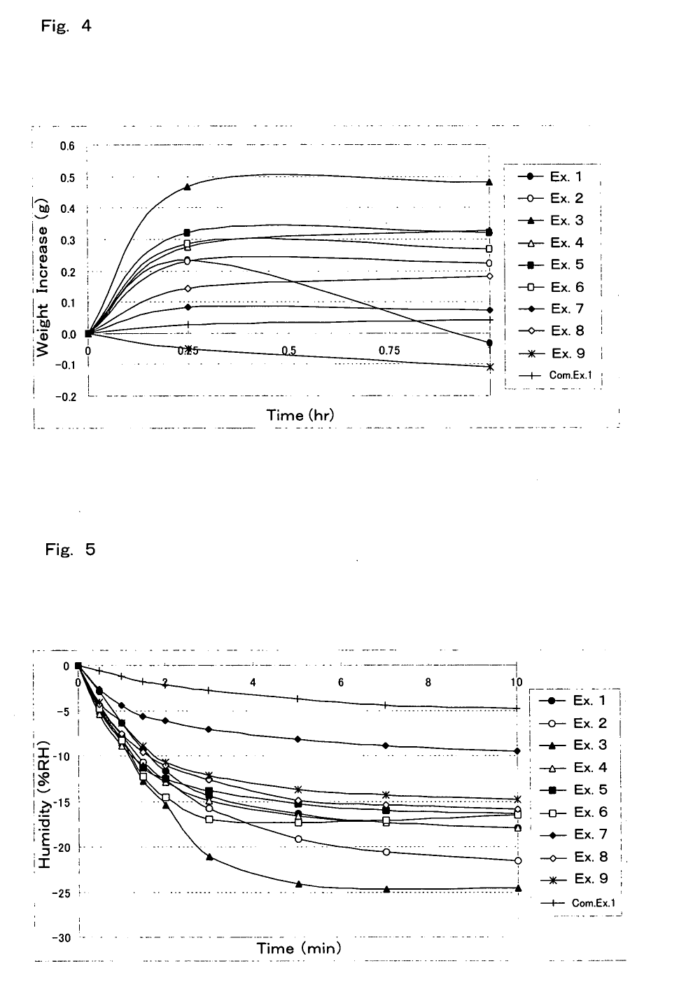

FIG. 4 shows the weight increases of each sample. It is seen from FIG. 4 that the weights of the samples according to Examples 2 to 6 greatly increased.

FIG. 5 shows the decrease in humidity over time when each sample was allowed to stand in an encapsulated container (volume: about 500 mL). It is seen from FIG. 5 that the samples according to Examples 2 and 3 exhibit high moisture absorption abilities.

Table 3 shows the transparency (parallel transmittance) of each desiccant layer before and after the moisture absorption of the sample (each sample was left standing for 1 hour at a temperature of 26.9° C. and a humidity of 59.7% RH).

It is seen from Table 3 that all the samples in accordance with Examples 1 to 9 are capable of maintaining sufficient transparency.

TABLE 3

| | Before Moisture | After Moisture |
|---|---|---|
| | Absorption | Absorption |
| Example 1 | 99 | 89 |
| Example 2 | 84 | 89 |
| Example 3 | 100 | 97 |
| Example 4 | 97 | 91 |
| Example 5 | 100 | 87 |
| Example 6 | 100 | 99 |
| Example 7 | 87 | 91 |
| Example 8 | 98 | 59 |
| Example 9 | 68 | 64 |
| Comparative Example 1 | 98 | 89 |

Calculated with the transmittance of the glass cap only (without desiccant thin film) being 100.

### Experimental Examples 1 to 3

The transparent desiccant thin films made from the desiccant solutions used in Examples 3 and 4, respectively, were checked for hygroscopicity when actually used in an organic EL device.

### <Fabrication of Organic EL Devices>

A glass substrate having an ITO transparent electrode (anode) layer formed thereon was prepared first. Organic EL layers were subsequently deposited on the anode. The organic EL layers sequentially included four layers, i.e., a hole-injecting layer, a hole-transporting layer, a light-emitting layer, and an electron-injecting layer from the anode layer-side. A cathode layer made of Al was then deposited on the electron-injecting layer. The basic organic EL device structure was thus fabricated.

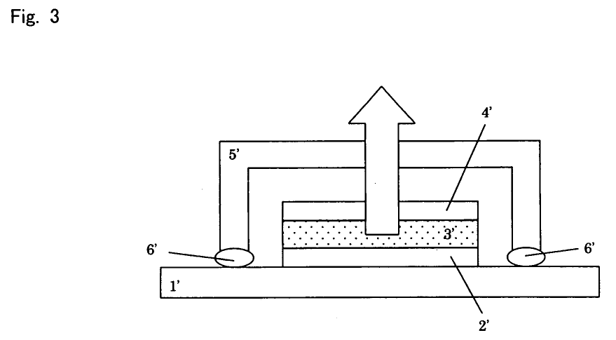

The seal member (seal cap) and seal material depicted in FIGS. 2 and 3 were prepared. The central portion of each seal cap was provided with a recess. The seal cap had a desiccant film over the inside surface of this recess, thereby serving as a seal cap having a desiccating means inside of its recess. The desiccant films were formed in accordance with the following procedure: about 0.15 ml of each desiccant solution was uniformly applied over the inside surface of the recess of the cap, followed by heating and drying at 200° C. for 10 minutes. The entire procedure was performed in an N₂ environment (H₂O concentration: 1.2 ppm; O₂ concentration: 5.6 ppm). The correspondence between each Experimental Example and the kind of desiccant is shown in Table 4 below.

TABLE 4

| | Kind of desiccant solution |
|---|---|
| Experimental Example 1 | Desiccant solution used in |
| | Example 3 |
| Experimental Example 2 | Desiccant solution used in |
| | Example 4 |
| Experimental Example 3 | No desiccant thin film was |
| | formed (Comparative Experiment) |

A seal cap as prepared above was attached to an organic EL device in the same N₂ environment as above. A seal material made of UV-curable resin was prepared as the aforementioned seal material. More specifically, sealing was performed as follows: the edges of the seal cap were brought into contact with the surface of the glass substrate through the seal material. The resin seal material was subsequently subjected to aging by UV radiation and one hour of heating (80° C.), and was cured.

### <Examination of Hygroscopicities>

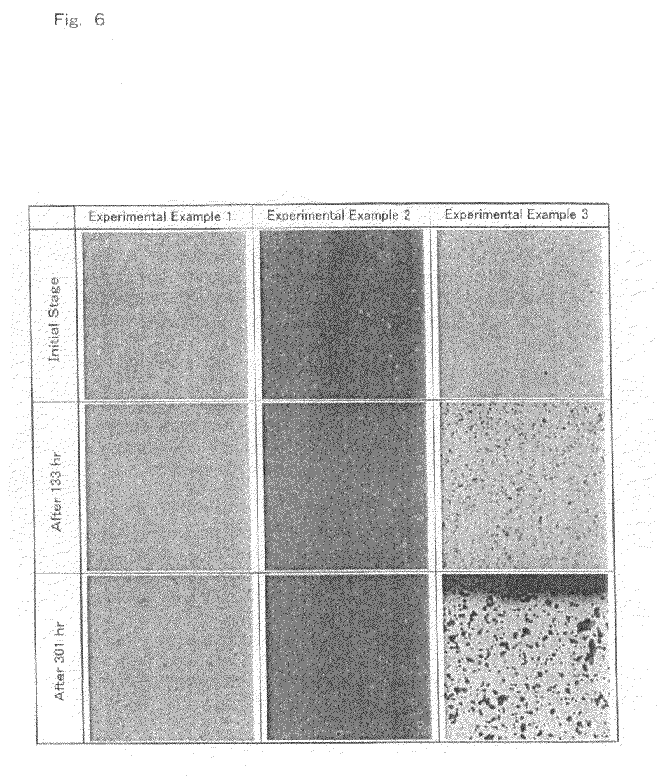

Organic EL devices, each using one of the three kinds of desiccants, were stored at a temperature of 60° C. and a humidity of 90% RH. The hygroscopicity of each device was checked by visually examining the growth of non-emission portions (darkspots) over time in the light-emitting layer. Hygroscopicity was rated as satisfactory if the growth of darkspots was not detected (or slow). The growth of darkspots was examined in the initial stage, after 133 hours, and after 301 hours, of storage. FIG. 6 shows the results of examination for darkspots over time.

As is clear from FIG. 6, the formation of darkspots after 133 and 301 hours was suppressed in the devices according to Examples 1 and 2 including desiccant films made of the transparent desiccants of the present invention. In contrast, the device of Example 3 without a desiccant film showed noticeable formation of darkspots after 133 hours, and the area of the darkspots had further increased after 301 hours. These results confirmed that transparent desiccants in accordance with the present invention exhibit satisfactory hygroscopicity, and are capable of sufficiently preventing the formation of darkspots when actually used in organic EL devices.

1. A transparent desiccant comprising an organometallic compound obtained by reacting a metal alkoxide with a polyol.

2. A transparent desiccant according to claim 1, wherein the metal alkoxide is a compound represented by general formula (1) shown below:
M(OR¹)ₐ (1)
wherein M is a group II element, a group III element or a group IV element; R¹ is a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents; and a is an integer of 2 when M is a group II element, an integer of 3 when M is a group III element, and an integer of 4 when M is a group IV element, and wherein
the polyol is a compound represented by general formula (2) shown below:
HO-Z-OH (2)
wherein Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group.

3. A transparent desiccant according to claim 1, comprising an organometallic compound represented by general formula (3) shown below:
(R¹O)_{b}M(OZOH)_{c} (3)
wherein M is a group II element, a group III element or a group IV element; R¹ is a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents; Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group; b is an integer from 0 to 2; c is an integer from 1 to 4; and b+c is 2 when M is a group II element, 3 when M is a group III element, and 4 when M is a group IV element.

4. A transparent desiccant according to claim 1, comprising an organometallic compound represented by general formula (4) shown below: 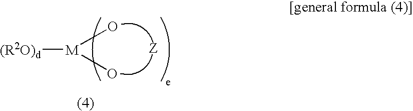
wherein M is a group II element, group III element or a group IV element; Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group; R² is a monovalent open-chain hydrocarbon group which may be substituted with one or more substituents, a monovalent alicyclic hydrocarbon group which may be substituted with one or more substituents, a monovalent monocyclic or polycyclic aromatic or heteroaromatic hydrocarbon group which may be substituted with one or more substituents, or a -ZOM(OZO) group where Z and M are the same as above; d is an integer from 0 to 2; e is an integer of 1 or 2; and d+e is 1 when M is a group II element, 2 when M is a group III element, and 2 or 3 when M is a group IV element.

5. A transparent desiccant according to claim 1, comprising an organometallic compound represented by general formula (5) shown below: 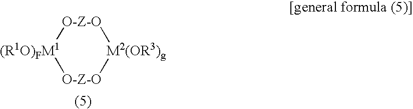
wherein M¹ and M² are the same or different, each being a group II element, a group III element or a group IV element; R¹ and R³ are the same or different, each being a monovalent open-chain hydrocarbon group which may be substituted with one or more substituents, a monovalent alicyclic hydrocarbon group which may be substituted with one or more substituents, or a monovalent monocyclic or polycyclic aromatic or heteroaromatic hydrocarbon group which may be substituted with one or more substituents; Z is a divalent open-chain hydrocarbon group which may be substituted with one or more substituents, a divalent alicyclic hydrocarbon group which may be substituted with one or more substituents, a divalent monocyclic or polycyclic aromatic or heteroaromatic hydrocarbon group which may be substituted with one or more substituents, an oxyalkylene group, or an iminoalkylene group; f and g are each independently 0 when M¹ or M² is a group II element, 1 when M¹ or M² is a group III element, and 2 when M¹ or M² is a group IV element.

6. A transparent desiccant according to claim 2, wherein the group II element is at least one element selected from the group consisting of Mg and Ca; the group III element is at least one element selected from the group consisting of B, Al and Ga; and the group IV element is at least one element selected from the group consisting of Si, Sn, Ti and Zr.

7. A transparent desiccant comprising a condensate obtained by condensing the organometallic compound according to claim 1 by a heat treatment.

8. A transparent desiccant according to claim 1 for use in an organic EL device.
